(19) United States
(12) Patent Application Publication
(10) Pub. No.: US 2003/0236667 A1
(43) Pub. Date: Dec. 25, 2003

(54) Computer-assisted language listening and speaking teaching system and method with circumstantial shadow and assessment functions

(76) Inventors: Say Ling Wen, Taipei (TW); Zechary Chang, Taipei (TW); Pinky Ma, Beijing (CN)

Correspondence Address: JACOBSON HOLMAN PLLC, 400 SEVENTH STREET N.W., SUITE 600, WASHINGTON, DC, 20004, US

(21) Appl. No.: 10/173,621

(22) Filed: Jun. 19, 2002

(51) Int. Cl. G10L 11/00

(52) U.S. Cl. 704/270

(57) ABSTRACT

A computer-assisted language listening and speaking teaching system and method that combines the functions of listening and speaking teaching and ability assessment with circumstantial teaching journeys to enhance a learner's language listening and speaking abilities through the process of repeatedly listening, shadowing and assessing. The system further includes the following units: an input control unit, a circumstantial database, a test unit, a play unit, a display unit and a recording unit. The method consists of the following steps: starting up the teaching system, entering into a teaching journey and executing a initial task; preparing a test and displaying shadowing teaching content based on test results; recording a shadow sound; playing a shadow sound; and processing teaching content assessment to complete a teaching journey.

### FIELD OF THE INVENTION

The invention relates to a computer-assisted teaching system, and particularly to a system and method that is utilized for processing a teaching journey of interactive language listening and speaking with circumstantial shadow (vocal imitation) and ability assessment.

### BACKGROUND OF THE INVENTION

In this age of the so-called global village there are more and more opportunities for people in the world to communicate, so an increasing number of people are eager to learn foreign languages. It is very important for people to catch on to what others say as well as to be understood by others during conversations in a foreign language. Hence, it has become a crucial task to enhance a learner's listening and speaking abilities with current foreign language teaching systems.

One focus of language instruction is listening comprehension, i.e., clearly listening to others and distinguishing meaning. Therefore, language training on listening comprehension requires one to find as many opportunities as possible to listen to people talking in a foreign language, so that one can become familiar with tones, speeds and intonation of a foreign language. Another focus of language instruction is speaking ability, in which the learner focuses on phonic pronunciations of a foreign language by way of vocal imitation practices that enable one to speak accurately and correctly and to be understood. Similarly, to develop language-speaking ability, one must repeatedly imitate and practice tones, speeds and intonation of a foreign language.

Conventional language training for listening and speaking abilities does not enable each learner to have actual opportunities to keep in practice, excepting for one-to-one physical teaching, which provides a teacher and a learner with opportunities for interactive language listening and speaking training. However, even one-to-one physical teaching requires a learner to spend too much time to achieve the effectiveness of constant practices and to have language ability assessment. It is not economical and ineffective and may make a learner fear becoming embarrassed in a one-to-one teaching situation, which will reduce the teaching effect. Moreover, the kind of one-to-one language teaching method that generally proceeds with fixed simulative subjects makes teaching not extensive over a wide range of subjects. This not only reduces a learner's interest in the learning process, but also limits pluralism of learning subjects. Hence, how to utilize presently well-developed computer technology for teaching a foreign language, which enables a learner to employ computer-assisted methods as well as to focus on constant listening and speaking practices, has become the focus of current language listening and speaking teaching.

### SUMMARY OF THE INVENTION

In view of the foregoing, the invention aims to provide a computer-assisted language listening and speaking teaching system and its method with the functions of circumstantial shadow and ability assessment. The goal of the disclosed system and its method is to combine language listening and speaking teaching with language ability assessment that enhances a learner's listening and speaking skills through an interactive teaching journey of repeated listening and speaking, with ability assessment.

To achieve the above-mentioned objects, the disclosed invention of a computer-assisted language listening and speaking teaching system and its method with circumstantial shadow and ability assessment functions consists of: an input control unit, an circumstantial database, a test unit, a play unit, a display unit and a record unit.

Furthermore, the disclosed invention consists of the following steps: starting up the teaching system, entering a teaching journey, executing initialized tasks, preparing a test, displaying a shadowing teaching content according to a circumstantial subject, recording shadowing sounds, playing shadowing sounds, and finally, proceeding with content assessment to complete the teaching journey.

The feasibility and practicality of the invention will be elaborated by means of an embodiment depicted in the following.

### BRIEF DESCRIPTION OF THE DRAWINGS

FIG. 1 is a systematic structure of the invention.

FIG. 2-a is an operational flowchart of the invention.

FIG. 2-b is a detailed flowcharted representation of content assessment of the invention.

FIG. 3-a is a shadow representation of the invention.

FIG. 3-b is an assessment representation of the invention.

### DESCRIPTION OF THE PREFERRED EMBODIMENT

This invention is a computer-assisted language listening and speaking teaching system and method with the functions of circumstantial shadows and ability assessment. It utilizes circumstantial subjects with related foreign language sentences for processing listening and speaking training, which includes listening, vocal imitation and ability assessment. The disclosed invention combines language listening and speaking teaching with ability assessment to enable a learner to completely learn foreign language listening and speaking through a series of interactive teaching journeys.

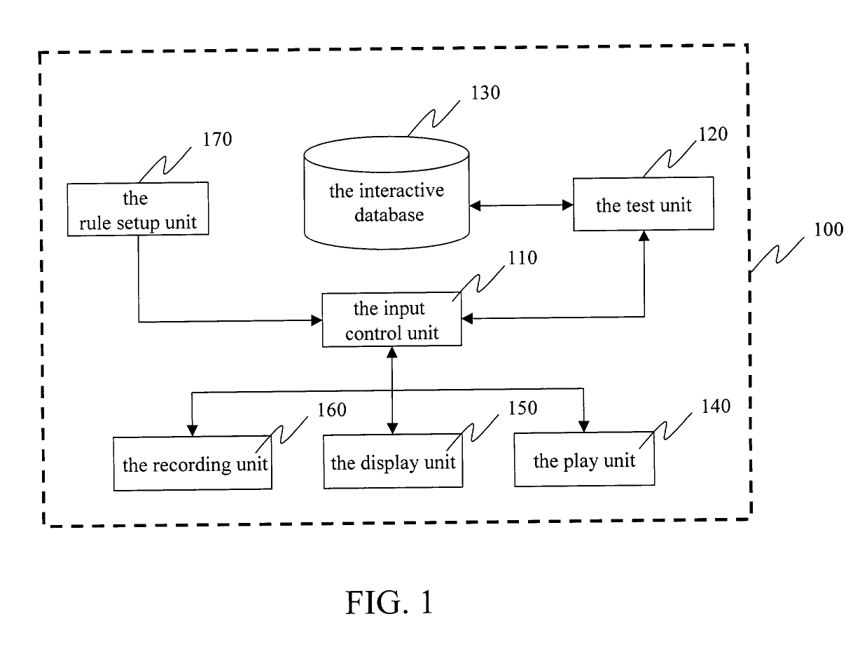

FIG. 1 is a systematic structure of this invention. The systematic structure is described as follows.

(1) An input control unit 110 processes the operations of various functions during a teaching journey. It further includes displaying, stopping, shadowing, continuing, etc. to enable a learner to control displayed pictures, sounds and scripts.

(2) A test unit 120 prepares a test and assess a leaner's language ability. The test unit 120 chooses circumstantial teaching content from a circumstantial database 130 to enable a learner to do shadow listening and speaking training. Moreover, according to the circumstantial teaching content, the test unit 120 provides the learner with a test of literal and phonic questions for ability assessment once s/he finishes the circumstantial teaching content.

(3) A circumstantial database 130 stores various interactive subjects. Each interactive teaching element consists of speaking imitation activities and tests. The speaking imitation activities mainly provide interactive images for a learner to browse and an interactive reiteration paragraph for a learner to listen to and imitate. The tests mainly provide an interactive phonic contextual paragraph and an interactive literal contextual paragraph for assessing a learner and answers to an interactive contextual paragraph for correcting a learner.

(4) A play unit 140 plays speech sounds of the teaching journey according to preset contents of the invention and the operation of a learner, such as standard interactive reiterative phonics, a learner's speaking imitation, interactive phonic contexts, etc.

(5) A display unit 150 processes interactive display of the teaching journey according to pre-set contents of the invention and the operation of a learner, such as interactive images, etc.; and literal display, such as interactive literal contexts, answers for interactive literal contexts, etc.

(6) A record unit 160 records a learner's speaking sounds during the teaching journey according to pre-set contents of the invention and the operation of a learner.

The disclosed invention further consists of a rule setup unit 170, which sets up general rules of the system, including playing setup (e.g. playing speed, playing times, etc.), displaying setup (e.g. displaying timing, displaying speed, etc.), shadow playing setup (e.g. shadow recording timing, shadow playing speed, shadow playing times, etc.), and answering setup (e.g. answering timing, etc.)

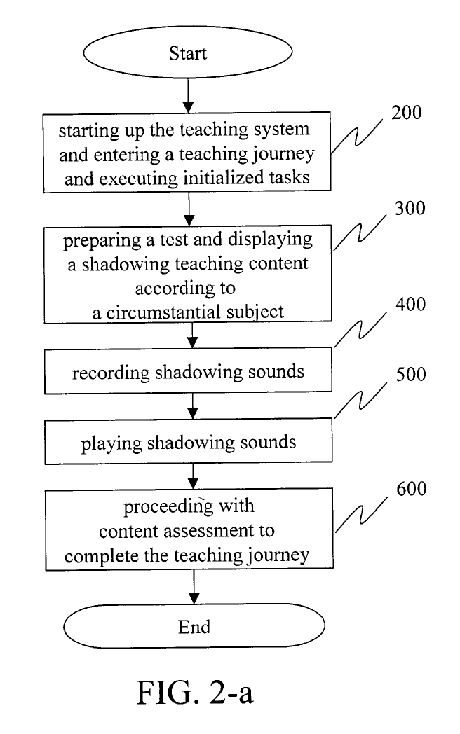

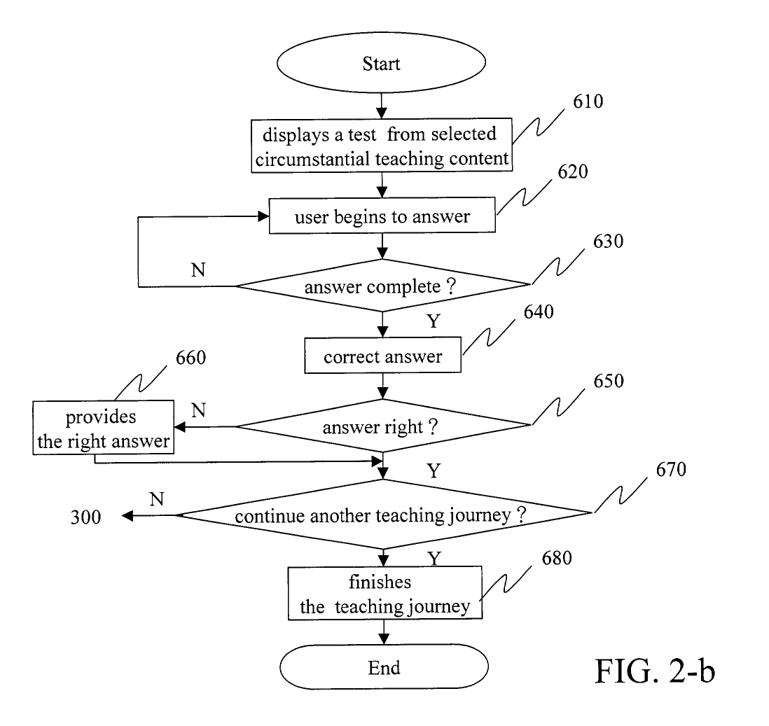

FIG. 2-a illustrates the operational flowchart of the invention.

First, a learner has to start up the teaching system and enter into a teaching journey. The system then executes the initial task (step 200), which is to pre-set various settings (including playing setting, displaying setting, shadowing play setting, answering setting, etc.), and starts to prepare a test. When the system sets out a test of circumstantial content based on a circumstantial condition, it displays shadowing teaching content (i.e., a circumstantial image and a circumstantial standard shadow sound) for the learner and enables him/her to process the operations of browsing, playing and controlling the shadowing teaching content (step 300). When the learner is completely familiar with the shadowing teaching content, the system starts up a shadowing teaching journey for the learner. A teaching journey consists of: recording a learner's shadow sounds (step 400); playing the shadow sounds of both his/her vocal imitation and of the circumstantial standard shadow content provided by the system (step 500); and processing ability assessment according to the learner's selected circumstantial teaching content (step 600) when the learner considers him/herself to be familiar with the circumstantial teaching content on a certain level. To further describe ability assessment, FIG. 2-b illustrates a detailed flowcharted representation of teaching content assessment of the invention.

A learner enters the ability assessment part when s/he completes his/her learning of the shadowing teaching content. The system firstly displays a test from selected circumstantial teaching content (including a circumstantial phonic context and a circumstantial literal context) (step 610) for the learner to answer, and then waits for the learner to make a move (step 620). The system continues to wait if the learner does not respond (step 630), or starts to correct answers (step 640). If the learner's answer is wrong, the system provides the right answer for the learner (step 660); if the learner's answer is right, the system asks the learner either to finish the teaching journey or to continue another teaching journey (step 670). If the learner chooses another teaching journey, the process goes back to step 300; or, the process finishes the teaching journey (step 680).

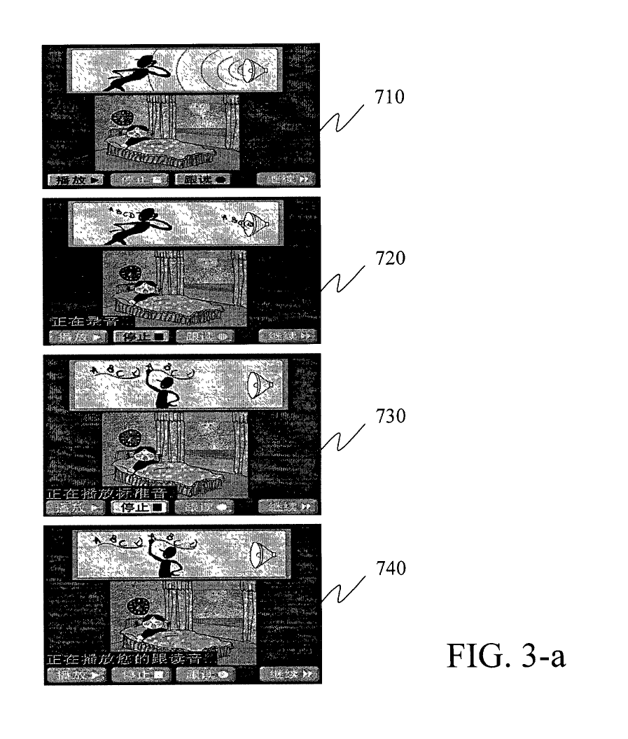

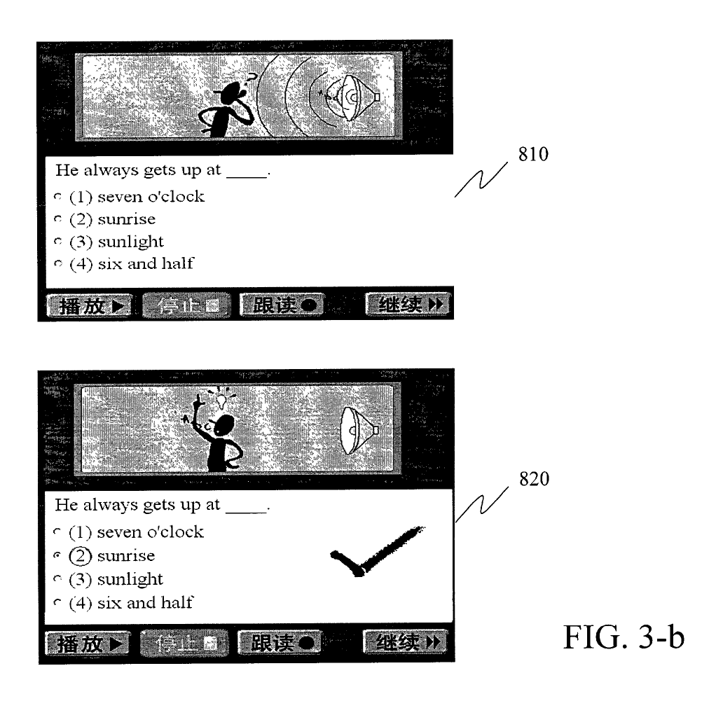

The feasibility and practicality of the invention will be elaborated by means of an embodiment depicted in the following. FIGS. 3-a and 3-b describe a shadowing teaching journey and an assessing teaching journey of the invention as follows.

At the beginning, the system selects circumstantial teaching content as a guide for assessing a learner's shadow sounds and displays shadowing teaching content 710 of the circumstantial teaching content for a learner to browse and listen to. Soon after the learner is familiar with the content, the system allows the learner to process self-shadowing learning. It enables a learner to firstly record vocal imitation 720, then after finishing recording, s/he can repeatedly play speaking sounds of both standard shadow sounds 730 and his/her shadowing imitation 740 to further enhance his/her language-speaking ability. Completing listening and speaking exercises, the learner can immediately assess his/her listening and speaking. The system displays assessing teaching content 810 of the selected circumstantial teaching content for the learner and automatically corrects the learner's answer after the learner answers a question 820.

### ACHIEVEMENTS OF THE INVENTION

The disclosed computer-assisted language listening and speaking teaching system and method with features of circumstantial shadow and assessment utilizes circumstantial subjects as guides to deepen a learner's understanding of teaching journeys and further increases a learner's learning interest and learning effects. A learner is capable of utilizing the disclosed system that combines the functions of listening and speaking teaching and ability assessment for putting what has been learned into practice through the process of repeatedly listening, shadowing and assessing. Furthermore, a learner learns the essential elements of language listening and speaking: tones, speeds, and intonation, through computer assisted instruction.

The disclosed system enables a learner to enhance his/her listening and speaking abilities of a foreign language through computer assistance without spending too much time and money to find a one-to-one course and worrying about being embarrassed. It helps a learner to truly enhance his/her listening and speaking abilities of a foreign language by repeatedly exercising without the limitations of time and place.

An invention in the form of a computer-assisted language listening and speaking teaching system and method with features of circumstantial shadow and assessment is disclosed herein. These and other variations, which will be understood by those skilled in the art, are within the intended scope of the invention as claimed below. As previously stated, detailed embodiments of the invention are disclosed herein; however, it is to be understood that the disclosed embodiments are merely exemplary of the invention that may be embodied in various forms.

What is claimed is:

1. A computer-assisted language listening and speaking teaching system relates to a system that employs a combination of listening and speaking teaching and assessing a learner's language abilities to complete an interactive foreign language listening and speaking teaching journey, the system comprising:
an input control unit, is to enable a learner to control the operation of a teaching journey process;
a circumstantial database, is to store all circumstantial teaching contents;
a test unit, is to select the circumstantial teaching content from the circumstantial database for the learner to do shadowing and to do literal and phonic Q&A test based on the circumstantial teaching content;
a play unit, is to play sounds according to the system settings and the operation of the teaching journey;
a display unit, is to display conditions and scripts according to the system settings and the operation of the teaching journey; and
a record unit, is to record speaking sounds according to the system settings and the operation of the teaching journey.

2. The system of claim 1, wherein the system further comprising a rule setup unit, to set up a basic rule of the teaching journey.

3. The system of claim 2, wherein the basic rule consists of a playing setup, a displaying setup, a shadow playing setup and an answering setup.

4. The system of claim 1, wherein the circumstantial teaching contents further consists of a shadowing teaching content and an assessing teaching content.

5. The system of claim 4, wherein the shadowing teaching content further consists of a circumstantial image and a circumstantial standard shadow sound.

6. The system of claim 4, wherein the assessing teaching content further consists of a circumstantial phonic context, a circumstantial literal context and a circumstantial contextual answer.

7. A computer-assisted language listening and speaking teaching system relates to a system that employs a combination of listening and speaking teaching and assessing a learner's language abilities to complete an interactive foreign language listening and speaking teaching journey, the method further comprising the following steps:
starting up the teaching system, entering into a teaching journey and executing a initial task;
preparing tests and displaying a shadowing teaching content according to a test circumstance;
recording a shadow sound;
playing a shadow sound; and
proceeding with content assessment to complete a teaching journey to a learner.

8. The method of claim 7, wherein the initial task further consists of a playing setup, a displaying setup, a shadow playing setup and an answering setup.

9. The method of claim 7, wherein the shadowing teaching content further consists of a circumstantial image and a circumstantial standard shadow sound.

10. The method of claim 7, wherein the step of proceeding teaching content assessment to complete the teaching journey to the learner further consists of the following steps:
displaying an assessing teaching content according to a test circumstance;
answering the question by a learner;
correcting an answer; and
completing the teaching journey.

11. The method of claim 10, wherein the assessing teaching content further consists of a circumstantial phonic context, a circumstantial literal context and a circumstantial contextual answer.

12. The method of claim 10, wherein the step of reading an answer further includes a step of providing the right answer for correction while a learner's answer is wrong.
